(19) United States
(12) Patent Application Publication
(10) Pub. No.: US 2020/0216292 A1
(43) Pub. Date: Jul. 9, 2020

(54) Truck Mounted Vacuum Material Handler and Quick Disconnect

(71) Applicant: Vacuworx Global, LLC, Tulsa, OK (US)

(72) Inventors: William J. Solomon, Tulsa, OK (US); James K. Hays, Tulsa, OK (US)

(21) Appl. No.: 16/818,574

(22) Filed: Mar. 13, 2020

Related U.S. Application Data
(63) Continuation of application No. 15/332,547, filed on Oct. 24, 2016.
(60) Provisional application No. 62/244,827, filed on Oct. 22, 2015.

(51) Int. Cl. B66C 1/02; B66C 3/00; B66C 23/36

(52) U.S. Cl. CPC B66C 1/0237; B66C 1/0243; B66C 1/0287; Y10T 403/592; B66C 1/0262; B66C 23/36; B66C 3/005

(57) ABSTRACT

A truck-mounted vacuum material handler and quick disconnect for use on a truck with a with a boom for handling plate steel. The handler includes a coupler [32] that has a boom connector [44], a removable carrier [36, 38] with a carrier connector [60], and a base [34] located between the boom connector and the removable carrier. A locking mechanism [66] located in the base is arranged to move between an unlocked position and a locked position relative to the carrier connector. In the unlocked position the carrier connector is removable from the base. In the locked position the carrier connector is secured in the opening and opposing face surfaces [48, 50, 62] of the base and removable carrier are mated to one another. The removable carrier may include a rotator-receiving recess [42] or a rigging hardware eyelet [40] arranged opposite the carrier connector.

### CROSS-REFERENCE TO PENDING APPLICATIONS

This application is a continuation application claiming priority to U.S. patent application Ser. No. 15/332,547, filed Oct. 24, 2016, which claimed priority to U.S. Provisional Application No. 62/244,827, filed Oct. 22, 2015, both of which are incorporated herein by reference.

### BACKGROUND

The present invention relates to hydraulic disconnect systems designed to attach a vacuum plate handler or lifter to a truck-mounted boom.

Thick steel plates are commonly used on construction projects to cover hazards that range from 10-foot deep trenches across a road to a 6-inch difference in a sidewalk. Plate thicknesses in the neighborhood of one inch are not uncommon to support the weight of a car or truck as it crosses one of these openings.

These plates are typically delivered to the worksite by truck and their footprint is sized accordingly, typically 8- to 10-feet wide by 10- to 40-feet long. This size also provides sufficient weight and friction with the road surface to ensure it is not moved from its installed position by a braking or accelerating vehicle driving over the plate. Given these dimensions the plates typically range from 2,000 to 6,000 pounds.

Moving these plates has traditionally been accomplished by using a boom mounted on a flatbed truck. The plate is loaded and unloaded off the flatbed by a spring-loaded mechanism that is raised and lowered by a cable from the boom. The spring-loaded mechanism is extended through a rectangular hole in the center of the plate. Once the mechanism is inserted in this hole it expands to grab the sides of the hole. The plate can then be lifted. The spring-loaded mechanism and its use is well known in the field.

The prior art system for moving and lifting the plates has some significant problems. As the spring-loaded mechanism gets worn it can develop problems deploying to grab the hole in the plate. The hole in the plate can also become worn or blocked with debris that makes the connection between the spring loaded mechanism and the hole questionable. When the spring-loaded mechanism fails the plate will fall, presenting a risk for extreme personal injury and property damage.

The prior art system also suspends the spring-loaded mechanism and plate from the boom by a cable. This means the plate must be manually rotated about the cable by an operator next to the plate as it is being maneuvered into place. If the spring-loaded mechanism fails at this point it can land on the operator causing severe injury.

Even for an experienced operator, there are limits to how much a 6,000 pound plate suspended from a cable can be maneuvered. Therefore, the prior art system has limitations as to its ability to place the plate in confined locations.

The trucks used to deliver the plates also deliver other items such as trench cribbing and miscellaneous excavation and safety equipment. Because different lifting equipment or attachments must be used, the trucks material handler or lifter attachments must be changed over to lift and place this equipment.

What is needed, therefore, is a system and method for safely picking up and placing a steel plate, precisely maneuvering a steel plate into confined locations, and adaptable for lifting and placing other items.

### SUMMARY

Preferred embodiments of a truck-mounted vacuum lifter include a coupler that has a boom connector, a removable carrier that has a carrier connector, and a base located between the boom connector and the removable carrier. A locking mechanism located in the base is arranged to move between an unlocked position and a locked position relative to the carrier connector. The base may include an opening shaped complementary to the carrier connector and arranged to receive the carrier connector.

In the unlocked position the carrier connector is removable from the base and in the locked position the carrier connector is secured in the opening and opposing face surfaces of the base and removable carrier are mated to one another. The base has a landmark and the removable carrier has a complementary shaped opening to the landmark so that base and removable carrier can connect to one another in only one orientation.

The removable carrier may include a rotator-receiving recess arranged opposite the carrier connector and shaped complementary to a rotator connected to a frame of the truck-mounted vacuum lifter. Alternatively, the removable carrier may include a rigging hardware eyelet arranged opposite the carrier connector.

A fluid power source, which may be located on or within the frame of the vacuum lifter, is in communication with the means arranged to move the locking mechanism between an unlocked position and a locked position relative to the carrier connector. The base and removable carrier have one or more fluid passageways that are aligned and in communication with one another when the locking mechanism is in the locked position. The locking mechanism can be a race with balls and a locking ring that surrounds the race and urges the balls into a groove of the base's carrier connector opening.

### BRIEF DESCRIPTION OF THE DRAWINGS

FIG. 1 is a perspective view of a preferred embodiment of a coupler to connect a boom to a vacuum material handler.

FIG. 2 is a perspective view of the coupler's base.

FIG. 3 is a perspective view of a first removable carrier used to secure the vacuum lifter to the coupler's base.

FIG. 4 is a perspective view of a second removable carrier used to provide an eyelet for use with other rigging hardware such as a hook, chain or cable.

FIG. 5 is a cross section of the coupler in the open position.

FIG. 6 is a cross section of the coupler in the locked position;

FIG. 7 is a perspective view of the coupler connected to the boom and a vacuum lifter.

FIG. 8 is a perspective view of the frame of the vacuum lifter of FIG. 7.

### ELEMENTS USED IN THE DRAWINGS AND DETAILED DESCRIPTION

20 Vacuum material handler or lifter
22 Boom
24 Truck
26 Base of 22
28 End of 22
30 Rotator
32 Coupler
34 Base
36 First removable carrier
38 Second removable carrier
40 Eyelet
42 Recess
44 Connector to 28
46 Pin
48 Mating surface or face of 34
50 Mating surface or face of 36
52 Landmark
54 Pin
56 Opening to receive 54
58 Hydraulic connections
60 Connector (e.g. cylinder)
62 Mating surface or face of 38
64 Groove
66 Locking mechanism
68 Opening shaped complementary to 60
70 Race
72 Holes
74 Ball
76 Locking ring
78 Hydraulic or pneumatic cylinder
80 Biasing means
82 Onboard hydraulic motor
84 Vacuum pump
86 Alternator
88 Vacuum pads
90 Legs
92 Frame
94 Vertical plate
96 Horizontal flanges
98 Foundation
100 Eyelets

### DETAILED DESCRIPTION OF THE PREFERRED EMBODIMENTS

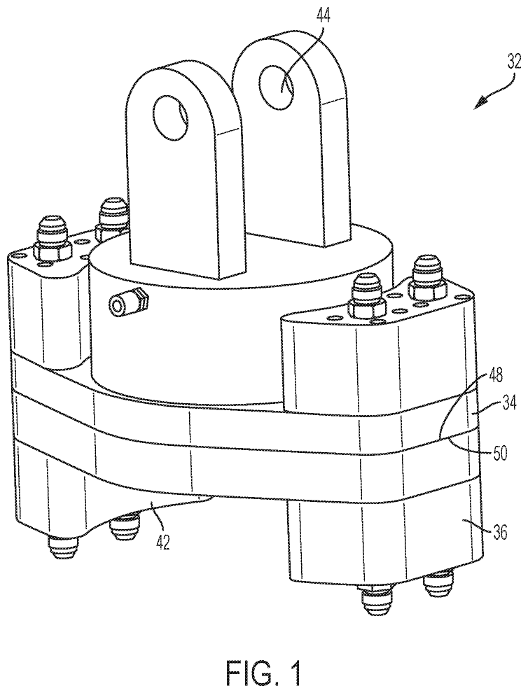

Referring first to FIGS. 1 & 7, a preferred embodiment of a coupler 32 for use with a truck-mounted vacuum material handler and quick disconnect secures a vacuum handler or lifter 20 to the end 28 of a telescopic boom 22 (mounted on a flatbed truck, not shown). A removable carrier 36 connects the vacuum lifter 20 to the coupler 32. The coupler 32 is attached to the end 28 of the boom 22 by a pivotal connection 44 that includes a pin 46. (Other types of joints could be used.)

Once connected, the boom 22 rotates about its base to position the vacuum lifter 20 in various places relative to the truck 24, tilts the boom 22 up or down, or extends and retracts the boom 22. The vacuum lifter 20 can be rotated about the end 28 of the boom 22 via operation of a rotator 30.

For lifting a thick steel plate, the vacuum lifter 20 has a pair of vacuum pads 88, each in communication with their own vacuum reservoir. A first solenoid-operated valve opens and closes fluid communication between the vacuum pad 88 and its respective vacuum reservoir. A second solenoid-operated valve provides the ability to open the vacuum pad 88 to atmosphere and release the vacuum pressure between the pad 88 and the plate the pad is lifting.

The vacuum lifter 20 is provided with a set of retractable legs 90 which can be lowered to store the vacuum lifter 20 on a flat surface without the pads 88 coming in contact with the surface. In the embodiment shown, the retractable legs 90 are pivotally connected to the lifter 20 and can be secured in a deployed position or a stowed position. Other types of connections can also be used.

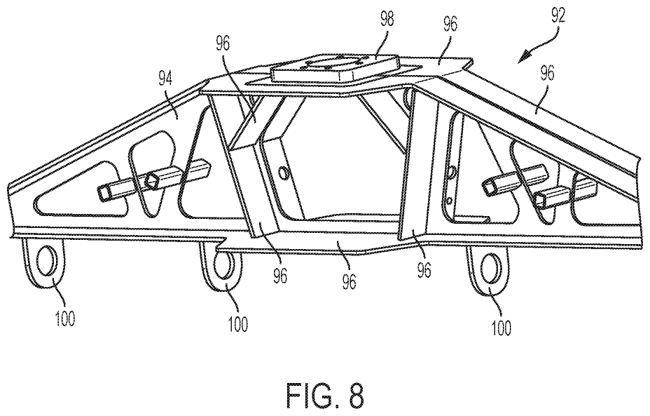

Referring to FIG. 8, the frame 92 of the vacuum lifter 20 is constructed from a vertical plate 94 with a plurality of horizontal flanges 96 to provide rigidity. The frame 92 has a foundation 98 for mounting the rotator 30 and an open bay (not numbered) for locating on board equipment such as a hydraulic motor, vacuum pump, alternator, and battery. A plurality of eyelets 100 on the bottom of the frame 92 provide a mounting point for the vacuum pads 88.

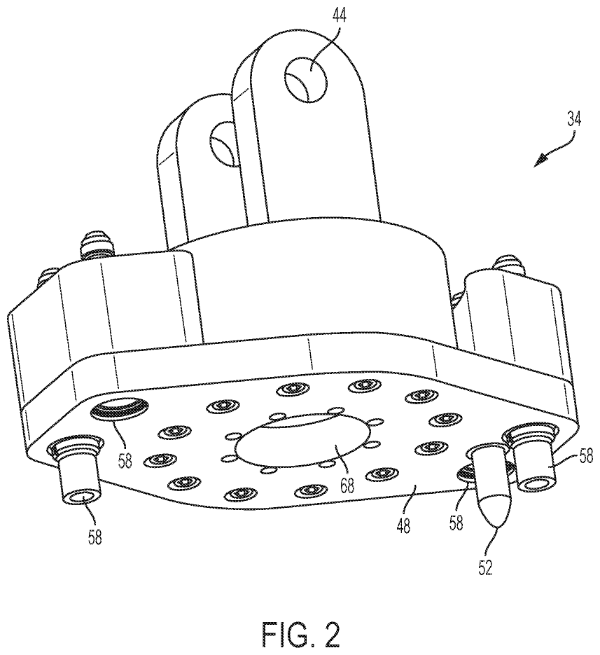

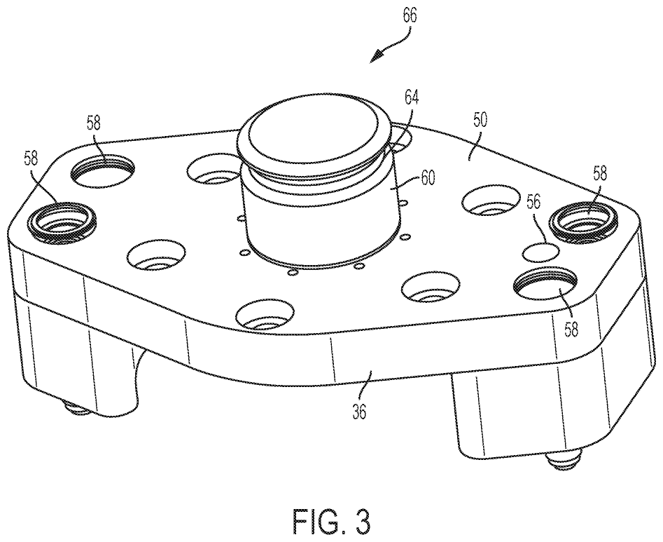

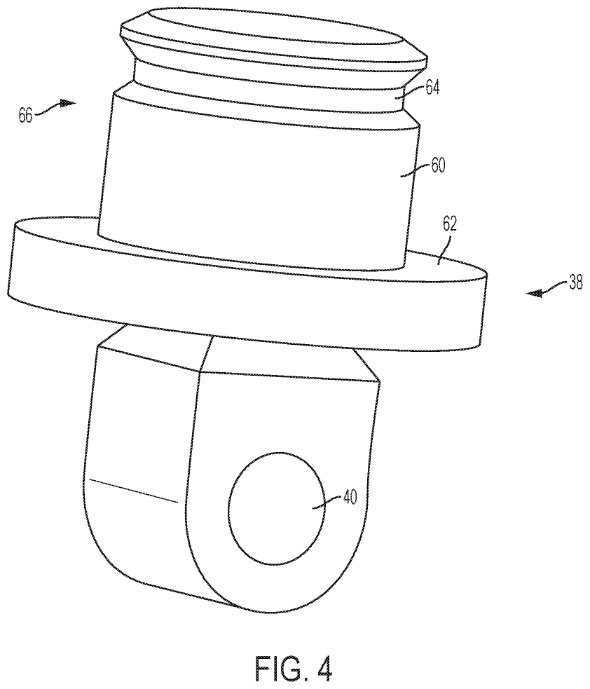

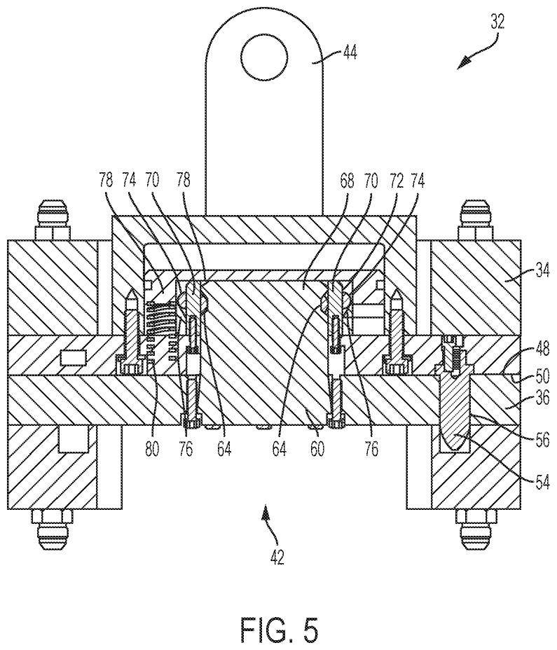

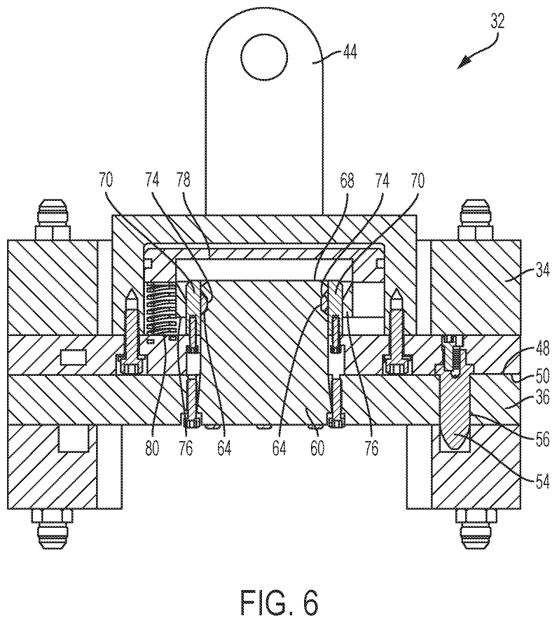

Turning now to FIGS. 1 to 6, the coupler 32 has a base 34 that can connect to a first removable carrier 36 or a second removable carrier 38. The first removable carrier 36 is used to secure the vacuum lifter 20 to the coupler's base 34. This carrier 36 includes a complementary shaped recess 42 to receive the rotator 30 and fastener holes (not numbered; see FIG. 3) to receive fasteners that connect the carrier 36 to the rotator 30. The second removable carrier 38 is used to provide an eyelet 40 for use with other rigging hardware such as a hook, chain or cable. Both carriers 36, 38 are arranged to quickly attach to and disconnect from the base 34.

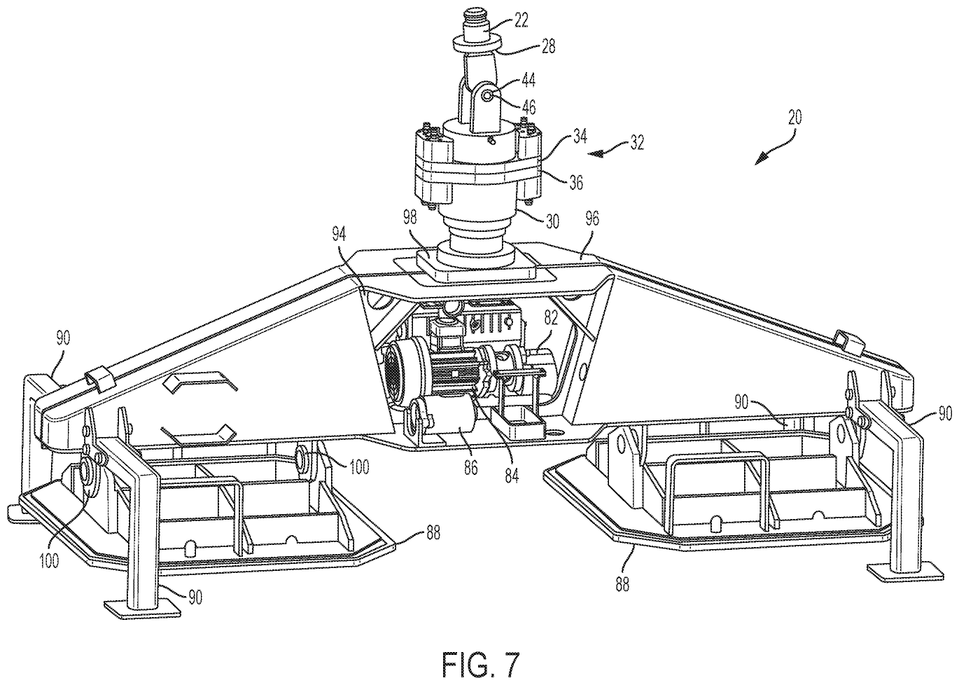

The mating surface 48 of the base 34 is complementary to the mating surface 50 of the first carrier 36. A landmark 52 ensures the base 34 and first removable carrier 36 can only connect in one orientation. In a preferred embodiment, the landmark 52 is a pin 54 that extends from the mating face 48. When the base 34 is connected to the first carrier 36, the pin 54 extends into a complementary opening 56 in the mating surface 50. The mating surfaces 48 and 50 also include one or more hydraulic connections 58. These connections 58 provide hydraulic fluid supply and return that power the rotator 30 and an onboard hydraulic motor 82. The motor 82 can power other equipment on the vacuum lifter 20 such as a vacuum pump 84 or alternator 86 (see FIG. 7).

A locking mechanism 66 secures the removable carriers 36 and 38 to the base 34. The locking mechanism 66 has a cylinder 60 that extends from the mating surface 50, 62 of its respective carrier 36, 38. A groove 64 extends around the side of the cylinder 60. The locking mechanism 66 also has an opening 68 that is sized and located to receive the cylinder 60 when the first or second carrier 36, 38 is attached to the base 34.

The opening 68 has a race 70 with a plurality of holes 72 each carrying a ball 74. The race 70 extends around the interior periphery of the opening 68, such that the balls 74 extend into the opening 68 when the locking mechanism 66 is in the closed or locked position. In the locked position a locking ring 76 extends around the race 70 forcing the balls 74 to extend beyond the holes 72 in the race 70 and into the opening 68.

In a preferred embodiment, the locking ring 76 is a part of or connected to a hydraulic or pneumatic cylinder 78. Operation of the cylinder 78 moves the locking ring 76 between the open and locked positions. In the embodiment shown, a biasing means 80, preferably one or more springs, holds the locking ring 76 in the locked position. The hydraulic or pneumatic cylinder 78 can then be operated to overcome the force of the biasing means 80 and move the locking ring 76 to the open position.

When the locking mechanism 66 is in the locked position and the first or second carrier 36, 38 is in the opening 68, the carrier 36, 38 is secured to the base 34 by the balls 74 extending into the groove 64. When the locking mechanism 66 is in the open position, the locking ring 76 moves out of alignment with the race 70. This allows the balls 74 to roll radially outward away from the opening 68 and out of the groove 64 so the first or second carrier 36, 38 can removed from the opening 68.

The foregoing description details certain preferred embodiments of the present invention and describes the best mode contemplated. Changes may be made in the details of construction and the configuration of components without departing from the spirit and scope of the disclosure. Therefore, the description is exemplary, rather than limiting, and the true scope of the invention is defined by the following claims and the full range of equivalency to which each element of the claims is entitled.

What is claimed is:

1. A method for connecting and disconnecting a vacuum lifter to and from a boom of a motorized piece of equipment, the method comprising:
connecting a coupler [32] to a rotator [30] of a frame [92] of the vacuum lifter, the frame including at least one vacuum pad [88], the coupler including:
a first removable carrier [36] at a lower end of the coupler; and
a base [34] at an upper end of the coupler;
the first removable carrier including a rotator-receiving recess [42] configured for connection about the rotator and, opposite the rotator-receiving recess, a planar face surface [50] and a first carrier connector [60], the first carrier connector insertable into a complementary-shaped opening [68] of the base;
the base including a boom connector [44] and, opposite the boom connector, a planar face surface [48] containing the complementary-shaped opening, the complementary-shaped opening including a locking mechanism [66] arranged to move between an unlocked position and a locked position relative to the first carrier connector when the first carrier connector is inserted into the complementary shaped opening;
inserting the first carrier connector into the complementary-shaped opening of the base, the face surface of the base and of the first removable carrier being mated to one another after the inserting; and
after the inserting, moving the locking mechanism into the locked position;
wherein, when in the locked position the frame is connected to the first removable carrier and the first removable carrier is secured to the base.

2. The method of claim 1, further comprising:
moving the locking mechanism from the locked position into the unlocked position, wherein when in the unlocked position the frame is connected to the first removable carrier and the first removable carrier is secured to the base.

3. The method of claim 2, further comprising:
removing the first carrier connector from the complementary-shaped opening, wherein after the removing, the first removable carrier is detached from the base; and;
inserting a second carrier connector [60] of a second removable carrier [38] into the complementary-shaped opening of the base, wherein after the inserting the coupler comprises the second removable carrier and the base, the second removable carrier not configured for connection to the rotator of the frame and including a planar face surface [62] and a rigging hardware eyelet [40] arranged opposite the second carrier connector, the face surface of the base and of the second removable carrier being mated to one another after the inserting; and
moving the locking mechanism into the locked position, wherein when in the locked position the second removable carrier is secured to the base.

4. The method of claim 1, wherein:
the base further includes a landmark [52]; and
the face surface of the first removable carrier includes a complementary-shaped opening [56];
the landmark of the base and the complementary-shaped opening of the first removable carrier being arranged so the base and the first removable carrier can connect to one another in only one orientation.

5. The method of claim 1, wherein the locking mechanism includes a spring-biased locking ring [76] and a race [70], the spring-biased locking ring located about a the race and arranged to move the race between the locked and the unlocked position.

6. The method of claim 5, wherein the base and the first removable carrier include one or more fluid passageways [58], the one or more fluid passageways being aligned and in communication with one another when the spring-biased locking ring is in the locked position.

7. The method of claim 1, wherein the locking mechanism is in fluid communication with a fluid power source [58, 84].

8. A vacuum lifter comprising:
a frame [92] including at least one vacuum pad [88] at a lower end of the frame and a rotator [33] at an upper end of the frame;
a coupler [32] including:
a first removable carrier [36] at a lower end of the coupler; and
a base [34] at an upper end of the coupler;
the first removable carrier including a rotator-receiving recess [42] configured for connection about the rotator and, opposite the rotator-receiving recess, a planar face surface [50] and a first carrier connector [60], the first carrier connector insertable into a complementary-shaped opening [68] of the base;
the base including a boom connector [44] and, opposite the boom connector, a planar face surface [48] containing the complementary-shaped opening, the complementary-shaped opening including a locking mechanism [66] arranged to move between an unlocked position and a locked position relative to the first carrier connector when the first carrier connector is inserted into the complementary shaped opening;
wherein, when the first carrier connector is inserted into the complementary-shaped opening of the base:
the face surface of the base and of the first removable carrier are mated to one another; and
the locking mechanism is moveable into the locked position; and
wherein, when in the locked position the frame is connected to the first removable carrier and the first removable carrier is secured to the base.

9. The vacuum lifter of claim 8, wherein, when in the unlocked position the frame is connected to the first removable carrier and the first removable carrier is not secured to the base.

10. The vacuum lifter of claim 9, further comprising:
the coupler further comprising a second removable carrier [38], the second removable carrier [38] including a second carrier connector [60], the second carrier connector insertable into the complementary-shaped opening the base subsequent to removable of the first removable carrier from the base;
the second removable carrier not configured for connection to the rotator of the frame, the second removable carrier connector including:
a planar face surface [62];
and a rigging hardware eyelet [40] arranged opposite the second carrier connector;
the face surface of the base and of the second removable carrier being mated to one another after insertion of the second carrier connector into the complementary-shaped opening of the base; and
wherein when in the locked position the second removable carrier is secured to the base.

11. The vacuum lifter of claim 8, further comprising:
the base including a landmark [52]; and
the face surface of the first removable carrier including a complementary-shaped opening [56];
the landmark of the base and the complementary-shaped opening of the first removable carrier being arranged so the base and the first removable carrier can connect to one another in only one orientation.

12. The vacuum lifter of claim 8, further comprising:
the locking mechanism including a spring-biased locking ring [76] and a race [70], the spring-biased locking ring located about the race and arranged to move the race between the locked and the unlocked position.

13. The vacuum lifter of claim 12, the base and the first removable carrier each including one or more fluid passageways [58], the one or more fluid passageways being aligned and in communication with one another when the race is in the locked position.

14. The vacuum lifter of claim 8, further comprising a fluid power source [58, 84], the locking mechanism being in fluid communication with a fluid power source [58, 84].

15. A vacuum lifter comprising:
a frame [92] including at least one vacuum pad [88] at a lower end of the frame and a rotator [33] at an upper end of the frame;
a coupler [32] including:
a first removable carrier [36] at a lower end of the coupler; and
a base [34] at an upper end of the coupler;
the first removable carrier including a rotator-receiving recess [42] configured for connection about the rotator and, opposite the rotator-receiving recess, a planar face surface [50] and a first carrier connector [60], the first carrier connector insertable into a complementary-shaped opening [68] of the base;
the base including a boom connector [44] and, opposite the boom connector, a planar face surface [48] containing the complementary-shaped opening, the complementary-shaped opening including a locking mechanism [66] arranged to move between an unlocked position and a locked position relative to the first carrier connector when the first carrier connector is inserted into the complementary shaped opening;
the base further including a landmark [52]; and
the face surface of the first removable carrier including a complementary-shaped opening [56];
the landmark of the base and the complementary-shaped opening of the first removable carrier being arranged so the base and the first removable carrier can connect to one another in only one orientation.
the locking mechanism including a spring-biased locking ring [76] and a race [70], the spring-biased locking ring located about the race and arranged to move the race between the locked and the unlocked position.
wherein, when the first carrier connector is inserted into the complementary-shaped opening of the base:
the face surface of the base and of the first removable carrier are mated to one another; and
the locking mechanism is moveable into the locked position; and
wherein, when in the locked position the frame is connected to the first removable carrier and the first removable carrier is secured to the base;
wherein, when in the unlocked position the frame is connected to the first removable carrier and the first removable carrier is not secured to the base.

16. The vacuum lifter of claim 15, further comprising:
the coupler further comprising a second removable carrier [38], the second removable carrier [38] including a second carrier connector [60], the second carrier connector insertable into the complementary-shaped opening the base subsequent to removable of the first removable carrier from the base;
the second removable carrier not configured for connection to the rotator of the frame, the second removable carrier connector including:
a planar face surface [62];
and a rigging hardware eyelet [40] arranged opposite the second carrier connector;
the face surface of the base and of the second removable carrier being mated to one another after insertion of the second carrier connector into the complementary-shaped opening of the base; and
wherein when in the locked position the second removable carrier is secured to the base.

17. The vacuum lifter of claim 15, the base and the first removable carrier each including one or more fluid passageways [58], the one or more fluid passageways being aligned and in communication with one another when the race is in the locked position.

18. The vacuum lifter of claim 15, further comprising a fluid power source [58, 84], the locking mechanism being in fluid communication with a fluid power source [58, 84].

19. The vacuum lifter of claim 15, the vacuum lifter having a lifting capacity in a range of 2,000 pounds to 6,000 pounds.

20. The vacuum lifter of claim 15, wherein the vacuum lifter is a truck-mounted vacuum lifter.
